(19) United States
(12) Patent Application Publication
(10) Pub. No.: US 2014/0070543 A1
(43) Pub. Date: Mar. 13, 2014

(54) MECHANISM FOR SHIFTING INCOMPRESSIBLE FLUID AND SERVO ASSISTED ROTATING MECHANISM

(71) Applicant: Nicola Massimo Massimo, Milano (IT)

(72) Inventor: Nicola Massimo Massimo, Milano (IT)

(21) Appl. No.: 14/115,423

(22) PCT Filed: May 4, 2012
(86) PCT No.: PCT/EP2012/058317

§ 371 Date: Nov. 13, 2013

(30) Foreign Application Priority Data
May 5, 2011 (EP) 11164950.5

(51) Int. Cl. F03G 3/00

(52) U.S. Cl. CPC F03G 3/00
USPC 290/1 R; 417/329

(57) ABSTRACT

A mechanism 1 transfers a fluid between vessels in closed circuit communication, the variable volume vessels 4e, 4c being fluid communication. Preferably the mechanism is a rotating mechanism and the vessels are hinged to an arm 2 pivoted to a support 12. In a stop/start position AP of the arm, the highest vessels 4e is in expanded condition and causes rotation of the arm 2 due to gravity until the vessels find themselves in reversed positions, with the expanded vessel 4e down and the compressed vessel 4c up. Expansion/compression means 8 act on the vessels as a consequence of gravity effect, thus causing the fluid to shift from the lowermost vessel to the uppermost vessel. The fluid transfer leads to the restoring of the initial condition and to a new rotation of the arm and vessels, bringing the expanded vessel downwards and the compressed vessel upwards. The vessels oscillate to help the arm rotation. In a further embodiment, the vessels move toward and away from the rotation axis of the arm, to increase the momentum. The fluid is thus transferred from one vessel to another without the need of any action from an operator.

### FIELD OF THE INVENTION

The present invention relates to a mechanism that is used to transfer a fluid or incoherent material from one vessel to another vessel, which vessels are placed at different heights and are in closed circuit communication. In particular the mechanism exploits the gravitational force for shifting the fluid form the lower to the higher vessel. For instance, the mechanism can be used for any application that requires shifting a fluid between two vessels at different heights.

### BACKGROUND OF THE INVENTION

Many mechanisms have been studied through the time for transferring a fluid from a vessel to another vessel placed at a higher position, however, for state of the art mechanisms, application of an external force, generally applied either by and operator or by a mechanical actuator, is needed. A completely autonomous and simple mechanism, capable of exploiting gravitational force would be highly appreciated. Possibly such gravitational force should be converted into mechanical energy and possibly into other forms of energy.

### OBJECT OF THE INVENTION

The object of the present invention is to overcome at least some of the drawbacks of the prior art.

An object of the present invention is to provide a mechanism capable of transferring an incompressible fluid (e.g. a liquid), from one position at a given height to a higher position, exploiting the gravitational force. In an embodiment of the present invention the fluid is contained in two vessels connected in a close circuit; also, in an embodiment of the present invention the relative position of the two vessels is then swapped, so as to reverse the motion of the material (e.g. fluid) being transferred, thus producing a cyclic motion of the mechanism and a cyclic transfer of the material, for instance from one vessel to another vessel.

Another object of the invention is to provide a mechanism that transfers the material from one vessel to another vessel, meanwhile producing a force necessary to rotate a crown wheel possibly used for any application (pumps, mechanical lifters, etc. . . . ) minimizing an operator action. Crown wheel rotation can also be used to produce, e.g. electric power. The vessels are alternatively placed a different heights, and the mechanism itself provides the necessary power to shift the vessels and possibly also power for any application (such as pumps, mechanical lifters, and so on) minimizing (or possibly eliminating) any action of an operator.

Another object of the invention is to provide a servo assisted rotary mechanism designed to exploit a weight shifting between fluid containing vessels in closed circuit communication.

Still another object of the invention is to provide the above mentioned mechanism equipped with means capable of exploiting the earth gravitational force for its operation, thus reducing, or possibly eliminating, any action of an operator or a mechanical actuator.

Yet a further object of the invention is to provide a mechanism with a rational configuration, simple to construct and functional, including a minimal number of parts, and requiring lowest maintenance.

### SUMMARY OF THE INVENTION

These and other objects are achieved by the present invention as claimed hereinbelow. In particular, according to the present invention, we provide a mechanism for transferring a fluid from at least a first vessel to at least a second vessel placed at a higher height with respect to the first vessel, the mechanism including: at least a first and a second variable volume vessels, the at least first and second vessel being in close circuit fluid communication; the at least second vessel being positioned upside-down with respect to the at least first vessel; compression/expansion means coupled to each vessel acting to contemporarily compress the at least first vessel and expand the at least second vessel, so that the at least first vessel undergoes a compression action and the at least second vessel undergoes an expansion action, thus causing the fluid to shift from the at least first vessel to the at least second vessel; wherein the compression/expansion means are activated by the gravitational force.

In a preferred embodiment the compression/expansion means include a weight coupled to each vessel, the weight exerting a compression action on the at least first vessel and an expansion action on the at least second vessel. The variable volume vessels are e.g. constituted by concentric stiff cylinders placed inside a flexible tight container. The cylinders are preferably made of a sufficiently stiff material capable of resisting the expansion and compression force caused by the earth gravity, e.g. one of the following: a metallic material, holed metal sheet, plastic material or a combination thereof.

According to another aspect of the present invention we provide a rotating mechanism supporting the mechanism above, wherein the at least first and second variable volume vessels are alternatively positioned at different heights, the at least first and second variable volume vessels being hinged to said rotary mechanism so that they can move along a closed loop path while keeping opposite positions with respect to said path, the rotating mechanism further including: stop means for determining a stop/start position for the rotary mechanism; wherein expansion/compression means act alternatively to expand/compress the at least first and second vessels in accordance with the position taken by the rotary mechanism, so that, with the rotary mechanism at the stop/start position, at the end of a rotation cycle, the highest vessel undergoes an expansion action and the lowest vessel undergoes a compression action, thus causing the fluid to shift from the lowest vessel to the highest vessel, which determines rotation of the vessels along the path following release of the stop means, thus moving downwards the expanded vessel and upwards the compressed vessel due to gravitational force effect and restoring the initial condition; and wherein the variable volume vessels oscillate during rotation to help the mechanism rotation.

Preferably the vessels are moved outwardly with respect to the closed loop path going away from the rotation axis, when they are in the expanded condition, and inwardly with respect to the closed loop path going closer to the rotation axis, while they are in the compressed condition, so as to increase the momentum when they move downwards and reduce the momentum when the moves upwards.

Also the rotating mechanism can include locking/unlocking means acting on the variable volume vessels so as to release the vessels, during rotation of said rotary mechanism, so that the vessels oscillate to help rotation of the rotary mechanism, and to lock the vessels, when the rotary mechanism dwells at the stop/start position, in a position such as to promote action of the expansion/compression means and fluid shifting from the lowest vessel to the highest vessel. Preferably the stop means, acting on the vessel support system, include magnetic or electromagnetic or mechanical devices or a combination thereof.

In a further embodiment the rotating mechanism includes at least one arm, pivoted to a support at a central position, so as to rotate coaxially in a substantially vertical plane with respect to the stop/start position determined by the stop means, with the variable volume vessels being each hinged to one of the opposite ends of said arm. Preferably the arm is connected to the support by means of a hub situated at its barycenter (or center of gravity), and wherein the support includes a pedestal or base, onto which one or two uprights are mounted, arranged substantially in vertical.

In another aspect of the present invention, the rotating mechanism includes at least one arm, pivoted to a support at a central position, so as to rotate coaxially in a substantially vertical plane with respect to said stop/start position determined by said stop means, wherein each end of at least one arm include first guide means extending longitudinally from the respective end toward the center of the respective arm, and wherein the variable volume vessels are in sliding engagement with the first guide means at each of the opposite ends of the at least one arm.

Preferably the arm is built with a substantially “Z”-like shape.

In a further embodiment radial moving means are provided which include at least one peripheral rail, with which the variable volume vessels are in sliding engagement.

Advantageously the at least one peripheral rail has its center offset toward the descending side of the rotation, and downwards. Preferably the upper part of the at least one peripheral rail is slightly flattened, so that the compressed vessel going up does not reach the uppermost point in the closed loop path.

Second guide means are also preferably positioned along the path of the compressed vessel going up, the second guide means having a curved contour facing away from the pivot point of the at least one arm and positioned in such a way that the at least one compressed vessel, while going up, slides resting on the curved contour, so that the at least one compressed vessel is supported in part by the curved contour of the second guide means while being overturned. The at least one arm is connected to the support by means of a hub situated at its barycenter, with the support composed of a pedestal or base, onto which one or two upright structures are mounted, arranged substantially in vertical at both sides of said arm.

In another embodiment the arms are two or more: they are connected to the support and are arranged parallel to each other, with each vessel being hinged to corresponding ends of both arms, and two peripheral rails are provided for radial movement of the vessels.

Preferably the ends of the at least one arm is curved along the length or part of the length where the guide means extend.

The first guide means can include a slot made longitudinally at each end of the at least one arm.

All rotating mechanisms described above, preferably include overturning means for turning the at least one expanded vessel at the end of the rotation, so that the vessels return in the initial configuration.

Also according to an embodiment of the present invention we provide a method for producing electric power, by using the rotating mechanism.

### BRIEF DESCRIPTION OF THE DRAWINGS

In the following, the invention will be explained in details, with reference to the accompanying drawings, in which:

FIG. 1 shows the mechanism with two variable volume vessels being connected in a close fluid circuit, according to an embodiment of the present invention

FIG. 2 shows a detail of the mechanism according to a preferred embodiment of the present invention

FIG. 3 shows schematically the rotating mechanism, out of scale, at the stop/start position (as referred to in the following), in its essential according to an embodiment of the present invention;

FIGS. 4-7 schematically show successive phases of the rotation step of the rotating mechanism according to an embodiment of the present invention: in particular FIG. 4 shows the mechanism of FIG. 3 in a position immediately preceding start of its operation cycle; FIG. 5 shows the mechanism in a characteristic moment, after completion of half a round from the stop/start position; FIG. 6 shows the mechanism in a characteristic moment, when oscillation ends and rotation is reversed, as described in the following; FIG. 7 shows the mechanism in the overturn characteristic step, as better defined in the following;

FIG. 8 shows a detail of the mechanism according to an alternative embodiment of the present invention;

FIG. 9 shows an alternative embodiment with the vessels (fluid containers) being positionable at a variable arm length in order to increase efficiency of the system.

FIGS. 10 to 12 show another embodiment of the present invention in three characteristic positions during one operation cycle;

FIG. 13 shows a lateral view of the embodiment of FIGS. 10-12 and a front view, both with the supporting structure;

FIG. 14 shows a working embodiment with example of dimensions and weights;

FIGS. 15 and 16 show a further embodiment of the invention.

### DESCRIPTION OF PREFERRED EMBODIMENTS

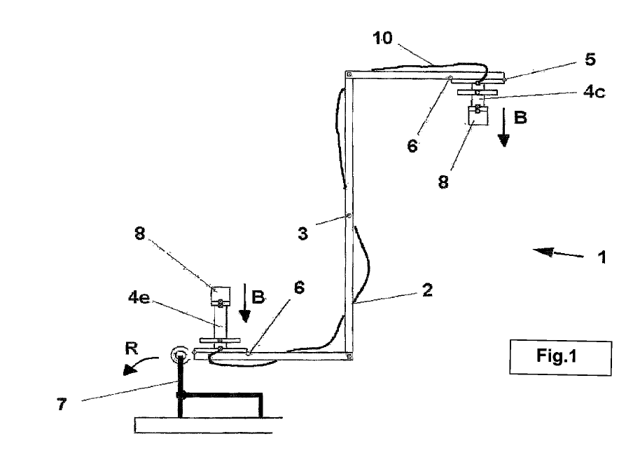

In FIG. 1 a preferred embodiment of the present invention is shown. In the mechanism (1) schematically shown in FIG. 1, two variable volume vessels (4e and 4c) are connected in close circuit: in a preferred embodiment of the present invention, the close circuit includes a flexible pipe (10) allowing the fluid communication between them. The two vessels are, for example, variable volume cylinders including concentric stiff cylinders contained within a flexible tight container (e.g. a rubber container).

The two vessels (4e and 4c) are supported by a rigid structure which keeps them at different height. In the example shown in FIG. 1, such rigid structure is an S shaped arm being pivoted to a support (not shown) through a hub 3. Also not shown are stop means which prevents the arm rotation.

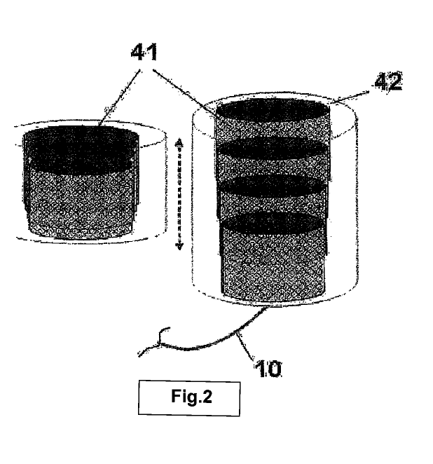

An example of variable volume cylinders is shown in FIG. 2. In particular, the cylinders 41 are made of a sufficiently stiff material capable of resisting the expansion and compression strain caused by the gravity (e.g. Earth gravity). For instance, the cylinders can be made of a metallic material, e.g. holed metal sheet, or alternatively a plastic material.

For the external container 42, rubber can be used or other impermeable materials, provided that they guarantee the liquid tightness of the closed hydraulic circuit, made of two containers and the pipe 10 connecting them.

Flexibility of the vessel allows the liquid to be pushed through the pipe, because of the compression, and to be withdrawn from the pipe, because of the expansion. As it will be more apparent hereinafter, when the liquid is transferred one of the vessels undergoes a compression (the lowest one) while the other undergoes an expansion.

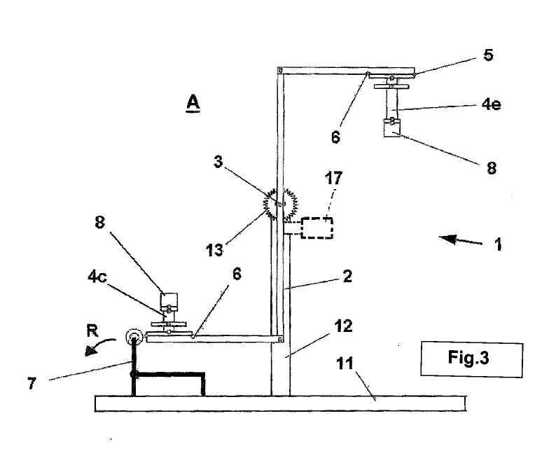

As shown in FIG. 1, one of the vessels is in expanded condition (4e where “e” stands for “expanded”), while the other one is in compressed condition (4c, where “c” stands for “compressed”). A weight 8 is provided to each variable volume vessel (4e and 4c): considering the action of the gravitational force on the weights 8, such weights exercise a compression force on vessel 4e and a traction force on the vessel 4c. In an initial step, the action of the two weights 8 is counterbalanced by e.g. stop means (not shown) which prevent the natural movement of the weight towards the center of gravity (normally the center of Earth). When the stop means are de-activated the combined action of two weights 8 push the expanded vessel (4e) and pull the compressed vessel (4c) along direction B, causing the fluid contained in the vessels to flow, through the pipe 10, from the lower vessel (4e) to the higher vessel (4c). At the end of the compression/extension step, the condition of the two vessels will be swapped, with the lower vessel being compressed and the higher vessel being expanded as schematically shown in FIG. 3.

In the example here described the fluid in the vessels can be water, preferably introduced without air.

Those skilled in the art will easily appreciate that the fluid could be replaced by other fluid, viscous liquid or incoherent materials, provided that they have the necessary incompressibility and fluidity characteristics, substantially similar to those of the water, possibly with the provision of necessary auxiliary devices. In the same way, even a not exactly fluid material, but with some typical fluid macro-features, could be used as an alternative (e.g. a multiplicity of incompressible microspheres).

The weight necessary for pushing the fluid from the lower vessel and pulling the fluid in the upper vessel must be over a value which can be determined by the formula:

Weight>Psf*Vc/2*Sc/Ssc

where
Sc is the surface of the vessel section;
Ssc is the surface of the column section;
Vc/2 is the half column Volume (column length/2);
Psf is the Specific Weight of the fluid.

The above formula is derived from the well known Pascal law referred to the fluid statics in linked vessels having diverse diameters.

In the present example the content of the expanded vessel 4e is about 2.5 liter, while the content of the compressed vessel 4c is about 0.5 liter; the weights (8) are metal plates with a mass of 10.5 Kg. The difference in height between the upper and lower vessel is about 2000 mm.

The above described mechanism for shifting a fluid (or fluid-like) material from a lower to a higher position can be used for several different purposes. Ideally such mechanism could be integrated in a more complex mechanism where, after the compression/expansion step during which the fluid is partially moved from the lower to the higher vessel, the initial conditions are re-established, bringing the expanded vessel 4e (which is now in the higher position as shown in FIG. 3) to the lower position. In such way the cycle could start again with the compression/expansion step.

FIG. 3 shows a possible implementation of such mechanism according to a preferred embodiment of the present invention. The mechanism 1 carries for rotation along a closed loop path, two variable volume vessels or containers 4e, 4c, as described above (the difference being that in the configuration of FIG. 3 the expanded vessel 4e is now in the higher position). In particular, in the instant configuration, the mechanism takes a shape substantially similar to the one of a bicycle pedal and comprises an arm 2 shaped substantially like a “Z”, at which ends the two vessels 4e, 4c are placed; the containers are connected together by a pipe (not shown here, but substantially similar to the pipe 10 described in FIG. 1).

The arm is connected to a support, by means of a hub 3 that is situated at its barycenter.

The support is composed of a pedestal or base 11 in which two uprights 12 are mounted, being arranged substantially in vertical, of which only one can be seen in FIG. 3. In other Figures (e.g. FIG. 1 described above), the support has been omitted, for clarity.

Externally, with respect to the uprights, there are placed one or two crown wheels 13, similar to bicycle chain wheels (only one of which can be seen in FIG. 2, and which are omitted in the other Figures for reason of clarity). As it will appear obvious to those skilled in this kind of technical issues, other equivalent embodiments are possible. As a mere example, the support could be composed by a single upright (or a plurality of uprights), or more than two crown wheels could be used or even only one. Moreover, the upright could be replaced by any other stand suitable for this purpose.

The arm 2 and the chain wheels 13 are connected by the hub (likewise a bicycle, in which this occurs by means of a so-called “central movement”).

In particular, the arm can be connected to the crown wheel(s) via a flywheel mechanism.

In this way the rotating motion of the arm is transmitted to the crown wheels in one-way fashion, with the advantages obviously obtained and which will be apparent from the following description.

Stop means 7 (schematically shown in FIG. 3) are mounted on the base 11 and perform a double task: they stop the arm oscillation motion, when it is in a stop/start position AP, and they release the arm 2, to allow it to run a subsequent half rotation starting from the stop/start position. The stop means, in a possible embodiment, include a vertical oscillating arm, aimed at stopping the arm 2. When the oscillating arm is rotated in a direction as indicated by the arrow and the letter R, it releases the arm, which can rotate.

Other kinds of stop means can be used, for instance acting directly on the arm 2 in other position, as indicated by dashed line 17 in FIG. 3.

The stop means as just described are obviously only some of the many possible embodiments of such mechanism, the only requirement being that of stopping and alternatively allowing the arm rotation in accordance with the changed weight conditions (i.e. filling, in the embodiment herein described) of the vessels.

In the subsequent Figures the stop means are generally not shown, for sake of clarity.

The variable volume vessels 4e, 4c are in fluid communication via a pipe 10 (which is also not shown in some Figures) and, according to a preferred embodiment of the present invention, are made up of concentric stiff cylinders contained inside flexible tight containers as described above with reference to FIG. 2.

Both the variable volume vessels 4e, 4c are hinged to the rotary mechanism, in particular they are hinged each one at or near one of the opposite ends of the arm 2. In particular, they are hinged with one of their corner, in particular the outer one, that is the corner that is farther from the rotation axis of the arm 2.

In this way, the vessels move along a closed loop path while being situated at opposite positions, with respect to such path, and with a stop/start position AP for the arm determined by the stop means 7. Locking/unlocking means 6 are provided acting on the variable volume vessels, and designed to release the vessels, during rotation of the arm, so that the vessels oscillate, in such condition e.g. outwards.

This feature aims at helping rotation of the arm by changing the length of the radius by which the expanded vessel rotates, that is to say, such length is increased, thus increasing the angular moment so obtained and creating a greater inertial effect.

In practice, this fact shifts the fulcrum towards the resisting force thus increasing the driving force effect.

Conversely, when the arm is in the stop/start position (FIG. 1, FIG. 3), the locking/unlocking means 6 lock the vessels in a position such to promote action of the expansion/compression means, which are instead released, and transferring of the fluid from the lowest vessel, expanded, to the highest one, compressed.

The locking/unlocking means, which can be magnetic, electromagnetic, mechanical (for example snap means), are only schematically indicated and not shown in detail, as they are within the reach of those skilled in the art.

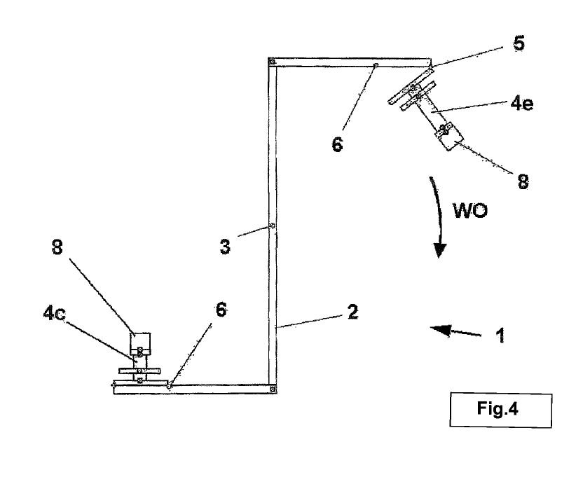

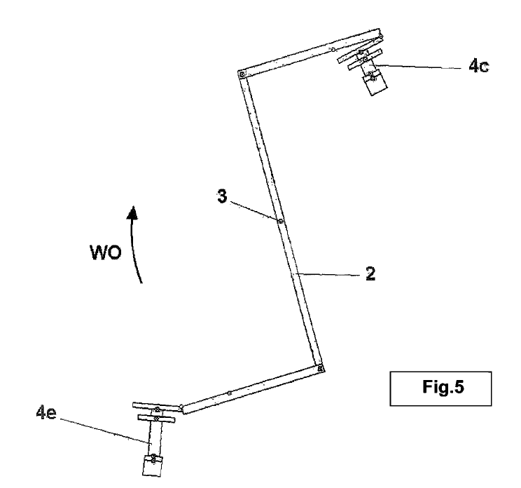

One of the vessels 4e is expanded and full of fluid while the other vessel is compressed and contains a smaller quantity of fluid, so that the expanded vessel (4e), which is situated at the highest point along the path, at the stop/start position, determines rotation of the arm and the vessels along the path following release of said stop means, thus moving downwards the expanded vessel and upwards the compressed vessel due to gravitational force effect (or the effect of any other equivalent force, e.g. an environment in which a centrifugal force simulate the earth gravity effect). The successive phases of the rotation step is illustrated in FIGS. 4-7

At the highest position reached by the expanded vessel (4e) during the rotation step the vessel is turned upside-down and, overturning means 9 are provided aimed at bringing the variable volume vessels and the expansion/compression means back to the position in which they are subject to the locking action of said locking/unlocking means.

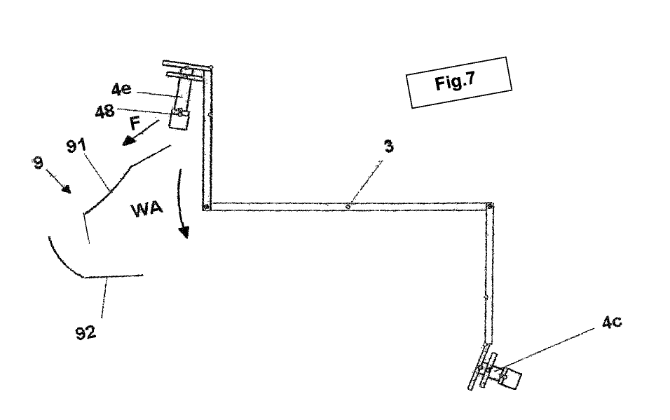

The overturning means, as shown in FIG. 7, include a track rail, or a track double rail, extending in subsequent curved and straight sections 91 and 92, which faces each other and have such shape as to cause overturning of the cylinder when it goes to contact them with one or two lateral extensions 48 suitable situated.

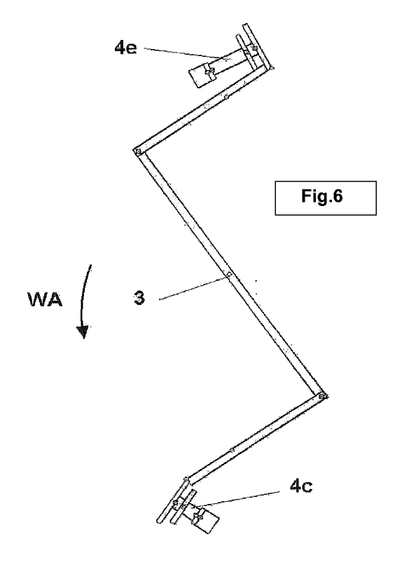

The lateral extensions 48, equipped with ball bearings or other means aimed at making negligible the friction due to sliding along the track rail or track double rail, are situated in a way such that the track rail or track double rail crosses the pathway run by them during the backward oscillation of the arm, in the counter-clockwise direction WA (see FIGS. 6 and 7).

During the forward oscillation, in the clockwise direction WO, the terminal part of the track rail is made to oscillate upwards, under the push of the cylinder 4e, letting it pass.

The overturning means action appears to be evident to the person skilled in the art, and the final result thereof is setting the cylinder 4e in vertical position, resting on the arm 2, restoring the starting conditions, i.e. those illustrated in FIG. 1 (before the compression/expansion step).

The arm rotation in the first direction, which can be defined clockwise WO with reference to the Figures, comes to an end when the expanded vessel reaches the uppermost position on the opposite side, after trespassing the lowermost point of the oscillation, with a pendulum motion.

In this position, the vessel is performing an oscillation, e.g. outwards, due to the centrifugal force, and the arm starts a backward downward motion, that is in counter-clockwise direction (FIGS. 6 and 7). In this step, the vessel overturning means 9 intervene, which intercept the vessel during the backward downward motion, so as to overturn it and bring it back to the initial position with respect to the arm.

The lateral extensions 48 slide along the sections 91 and then 92 of the overturning rail track, holding up the upper portion of the expanded cylinder 4e, causing it to overturn.

As soon as the expanded cylinder 4e goes in abutment against the arm 2, the locking/unlocking means 6 intervene, which lock the cylinder in that position.

According to the embodiment of the present invention just described, also the other vessel, that is the compressed one 4c, as a consequence of its oscillation, takes for a moment the position resting on the arm 2, as at the start condition (FIG. 1), and is then locked in such position by the locking/unlocking means, restoring the initial configuration.

For overturning the vessel 4e at the end of the rotation step, other alternative embodiments are possible. For example (not shown in the Figures) power means can be connected to the hinges of the vessels, such as a motor, designed to impart each time the expanded vessel 4e a partial rotation necessary to complete overturning. The motor can be activated at the moment in which the expanded vessel 4e will reverse its oscillation, thus making the vessel complete the oscillation motion and get overturned. Means can be provided to control the motor, such as a sensor detecting the oscillation reversal.

The motor can be powered by a battery charged for instance by a generator connected to the output shaft of the rotary mechanism.

Other means, for instance mechanical, can be provided in place of the motor. For instance, a leaf spring (not shown) can be connected to the hinge of each vessel, so that when the expanded vessel 4e moves downwards and oscillates in the counterclockwise direction WA, energy in excess is used to load the spring, which then helps the vessel at a later time with its elastic reaction.

Advantageously, both the spring and the motor can be mounted on the rotary mechanism.

Other mechanical means can be provided for performing the same action, these means being possibly known or easily conceived by those skilled in the art.

The overturning means action appears to be evident to the person skilled in the art, and the final result thereof is setting the cylinder 4e in vertical position, resting on the arm 2.

As explained above with reference to FIG. 1, in order to obtain the vessels expansion/compression action, expansion/compression means 8 are provided, which act alternatively to expand/compress the vessels 4e, 4c, in accordance with the position taken by the arm 2.

In the compression expansion step described above with reference to FIG. 1 the highest vessel, in the stop/start position AP of the arm, undergoes an expansion action, whereas the lowest vessel undergoes a compression action, thus causing the fluid to shift from the lowest vessel to the highest vessel.

This action will be repeated at the end of the rotation step for restoring each time the initial condition, as it will be more apparent in the following.

The expansion/compression means 8 include push/traction means, connected to the vessels 4e, 4c, and acting alternatively to push/pull them, by the action of gravity, in accordance with the position of the relevant vessel connection point thereof, i.e. above the vessel (compression) or below the vessel (expansion). Such position changes following rotation of the arm 2.

In the present example, the push/traction means include heavy masses joined to the vessels and acting to push the vessels downwards or to pull the vessels, again downwards. The expansion/compression means 8 can be locked to their position during rotation of the arm 2, so that their action occurs only at the start/stop position AP. To lock the position of the expansion/compression means 8 corresponding means can be provided, which are not shown in the Figures, but they can be easily conceived by those skilled in the art.

In accordance with an alternative embodiment of the present invention, which is not shown herein, the variable volume vessels can include cylinders, within which related plungers slides with relevant stems extending out of the cylinders.

The expansion/compression means are made to act on the stems.

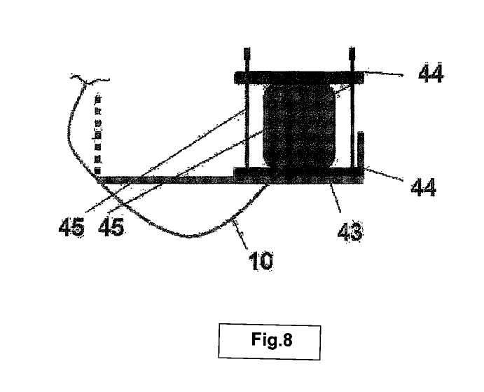

In accordance to another possible alternative embodiment, shown in FIG. 8, the variable volume vessels can substantially be made up of three parts:
the actual vessel, made of a substantially flexible container 43, interposed between two plates 44;
a plate connected to an end of the arm and fastened to the container;
another plate fastened to the opposite part of the container and free to slide along rods 45, to perform the compression or expansion action.

The essential characteristic of the mechanism, according to this preferred embodiment of the present invention, is the exploitation of gravity in two different steps. The compression/expansion step described above is followed by a rotation step, when the stop means allows the arm to rotate and assuming that the upper vessel has weight sufficiently greater than the lower vessel, the upper vessel moves towards the gravity centre (e.g. the centre of the earth) thus causing rotation of the arm 2.

At this point, the compression/expansion step starts again, in which the locking/unlocking system keeps the vessels in steady positions, and the stop means keep stopped the arm in the stop/start position, gravity pushes on the lowermost vessel (compressing it) by the compression means (e.g. the movable plate) while at the same time it pulls the uppermost vessel (expanding it) by the uppermost vessel expansion means (e.g. the movable plate).

The combined effect of these two actions causes the liquid to move from the lowermost vessel to the uppermost one, and consequently the weight is also transferred.

At the end of the vessel compression/expansion step, the compression means cause the release of the stop means. At the same time, a hydraulic closing mechanism cuts off the fluid communication from a vessel to the other one. Such mechanism must then reopen, at the end of rotation step, to allow the liquid transfer. Also in this case, the closing/opening mechanism is enabled and disabled by the weight action exerted by the compression means.

At this point, the stop means 7 let the mechanism free to rotate while the locking/unlocking means 6 unlock the expanded vessel 4e, which oscillates outwards, and the movement starts again with rotation step as described hereinabove, with the vessels at reversed positions.

After two expansion/compression steps and two rotation steps, alternate and consecutive, the vessels will take again their initial positions.

The sequence of the so called expansion/compression step and rotation step is not necessarily the one illustrated in the present example: they could be easily reversed, that is they could start with rotation step.

According to another embodiment, the vessels do not only oscillate, but are also moved outwardly with respect to the closed loop path going away from the rotation axis, when they are in the expanded condition, and inwardly with respect to the closed loop path and closer to the rotation axis, while they are in the compressed condition.

This motion of the vessels further increases the momentum when they move downwards and further reduces the momentum when they move upwards.

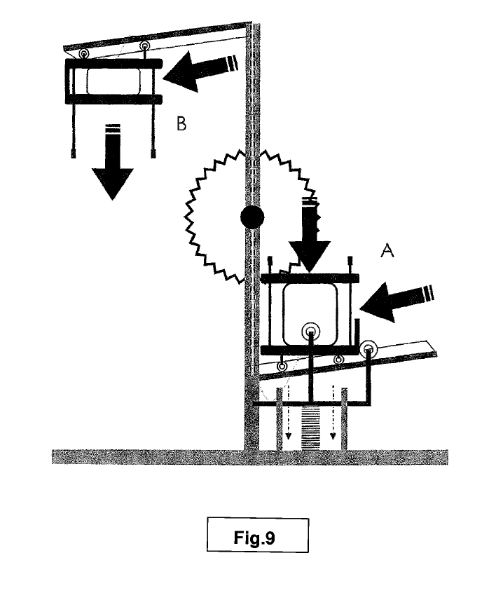

The vessels are moved outwardly and inwardly, due to gravity action, when the mechanism is stopped in the stop/start position. This can be seen, in the form of an exemplary embodiment, in FIG. 9.

As shown in FIGS. 1 and 3-7, the rotating mechanism is substantially a first class lever, in which the fulcrum is placed between the driving force (4e) and the resisting force (4c).

In order that after a half rotation another half rotation takes place, it is necessary to reverse the two forces: the resisting force must become the driving force and the driving force must become the resisting force. In order to obtain this result, it is necessary that the weight (or mass) be shifted from the container in the lower position to the container in the upper position, releasing the stop means and start a new half rotation. According to a preferred embodiment of the present invention, the machine exploits earth's gravity in order to shift the weight from the lower container to the upper container.

The combined actions of these pushes, both caused by gravity (or other force having analogous effect, such as a magnetic field) brings about the transfer of the liquid (or part thereof) from the lowermost vessel to the uppermost one, so that the half rotation described above, can be repeated.

Basically, the fluid transfer action from the lower vessel to the higher vessel, allows a part of the weight to be transferred, so as to obtain the reversal of the driving and resisting forces.

What has been illustrated in the drawings shows how this step takes place in accordance with a preferred embodiment of the invention.

The rotating mechanism can be built using several types of material: metal or metal alloy or wood as regards the structural part (arms, support and locking system); plastic or rubber or other material with impermeability and compressibility characteristics (e.g. cylindrical, hydrodynamic or oil-pressure pistons utilized as driving force in mechanic arms) for the vessels; the connecting pipes can be made of rubber or plastic metal or other materials with impermeability characteristics. When selecting the material for building the vessels, attention should be paid to limiting as much as possible the mass of non-driving components, i.e. any component excluding the fluid and the weights. Excessive additional weight could negatively affect the machine performances.

The method and system of the present invention can be implemented with several alternatives or additional embodiments. As an example, FIG. 9 is a schematic diagram of a possible alternative embodiment where the position of the vessels is movable along the end portions of the arm (in this case, forming an acute angle with the central element) so that the distance of the vessel from the barycenter is variable: in this way the fulcrum can be shifted towards the resisting force of the system, thus increasing the efficiency of the machine. Other possible solution to increase the efficiency is to use a so called “easy-crank” system to improve the rotation efficiency.

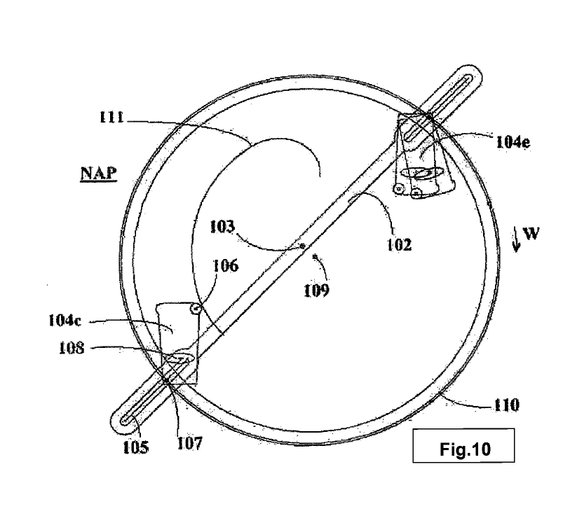

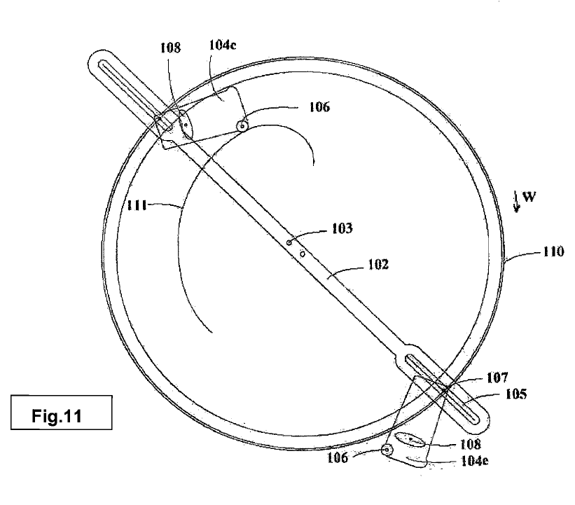

A further embodiment of the invention is shown in FIGS. 10 to 12, in which the vessels 104c, 104e (during rotation step) are moved with respect to the rotation axis of the mechanism during motion of the arm; in details, the vessel 104e and the vessel 104c are moved outwardly, while going down, and inwardly, while going up, respectively.

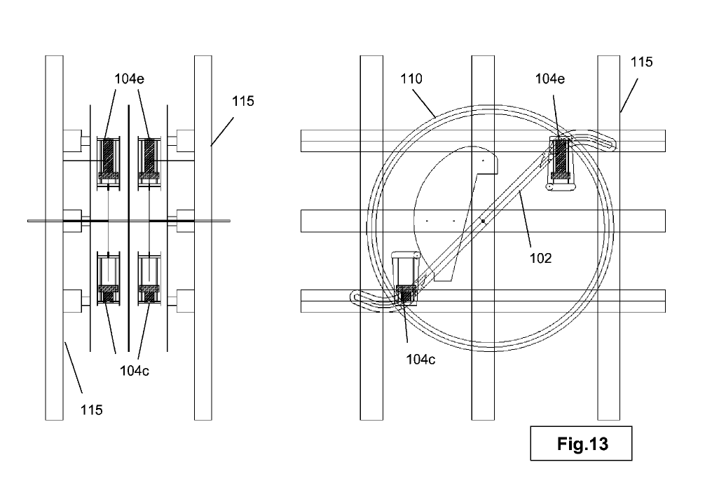

In particular, in the instant configuration, the mechanism includes a pair of arms 102, at whose ends the vessels 104e, 104c are hinged, in the way better described in the following. Each arm 102 has a pair of connected vessel 104e and 104c. In FIG. 10 only one arm 102 and one pair of vessels 104e and 104c is visible, while FIG. 13 shows a lateral view where the two arms can be seen. Also, in FIG. 13 the supporting structure 115 is shown, while in FIGS. 10-12 this is not evident for sake of clarity. Of course the mechanism can work even with one arm 102 only or 3 or more arms 102 and a corresponding pair of vessels 104e and 104c. The vessels are linked together by a pipe as describe for previous embodiments, which is not shown in the FIGS. 10-12 for better clarity.

The arms 102 are pivoted at their center, to a stationary support, not shown for sake of clarity, by means of a hub or hubs 103, so that they can rotate in reciprocal coaxial relationship, in substantially vertical planes.

While the description always refers to a pair of arms, it should be understood that only one arm or more than 2 arms could be used as well, with the provision of the necessary modifications, which will be obvious to those skilled in the art.

The arms can be connected to an output axle, also not shown, for example, but not limited thereto, via a crown wheel(s) also not shown, possibly with the interposition of a flywheel mechanism.

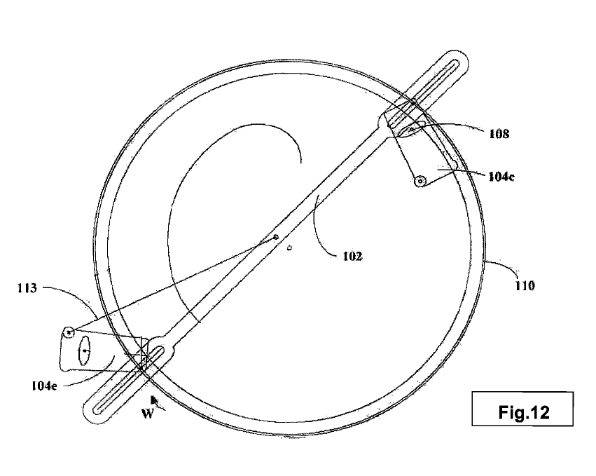

In this way, the rotating motion of the arms 102 is transmitted to the crown wheel(s) in one-way fashion, with the obvious advantages thus obtained and which will be apparent from the following description. In the following, rotation of the arms will be assumed to be always in the clockwise direction W, as shown in FIG. 12, this being only an example.

Stop means (which are similar to those of the embodiments previously disclosed and which are not shown in FIGS. 10 to 12) are mounted at a suitable position, for example at a position corresponding to the stop position intended for the arms.

Optionally, they could also be mounted at a different position, with the only provision that the stop the arm at the start/stop position as indicated in FIG. 10.

The stop means perform a double task: they stop the arms motion, when they are in a stop/start position NAP, and they release the arms 102 to allow them to move over a subsequent half rotation, starting from the stop/start position.

The stop means are not described herein, as they can be of any kind, with the only requirement of stopping and alternatively allowing the arm rotation in accordance with the changed weight conditions (i.e. filling, in the embodiment herein described) of the vessels.

Both the variable volume vessels 104e, 104c are hinged to the rotary mechanism, in particular they are hinged each one at or near one of the opposite ends of the arms 102. In this way, the arms are imposed a synchronous rotation about the hub 103 while the vessels 104c, 104e are taken along a closed loop path and are always situated at opposite positions, with respect to such path.

The connection hinge 107 of each vessel 104c, 104e is located at the outer corner of the vessel that means the corner which is farther from the rotation axis of the arms. Rollers 106 are fastened to the other corner of each vessel, for the reason that will be explained in the following. Each end of each arm 102 features longitudinal guide means, which include a slot 105, extending from the corresponding end of the respective arm 102 toward the hub 103. Other guide means could be used instead as can be easily appreciated by those skilled in the art.

The connection hinge 107 between each vessel 104c, 104e and the relative arms is in sliding engagement with a pair of facing slots 105 of the two arms. Consequently, each vessel can slide radially along the slots 105 toward and away from the rotation axis of the arms that is the hub 103.

The mechanism includes also radial moving means, formed by two peripheral rails 110, having substantially a circular shape, whose task is to control the radial movement of the vessels 104e, 104c.

The peripheral rails, coaxial and with the same diameter, have center 109 offset with respect to the hub 103 of the arms 102, toward the side of the mechanism where the variable volume vessels moves from up downwards, that is towards the right, taking in consideration the exemplary rotation direction of the arms in the clockwise directions W of FIG. 10. The center of the peripheral rails is also offset downwards.

The resulting right-downward offset distance is not greater than half the length of the slots 105.

The connection hinge 107 between each vessel 104c, 104e and the relative arms is in sliding engagement also with the peripheral rails 110. As a result thereof, when the arms rotate in the clockwise direction W, the vessel 104c, 104e not only move along a circular closed loop path, but they are also moved radially outwardly, while they are moving from up downwards, and inwardly while they are moving from down upwards.

The advantage of this reciprocatory radial motion of the vessels is to further increase the momentum when the vessels move downwards and to further reduce the momentum when they move upwards.

One of the vessels 104e is expanded and full of fluid while the other vessel is compressed and contains a smaller quantity of fluid, so that the expanded vessel, situated at the highest point along the closed loop path, at the stop/start position, due to gravitational force effect (or the effect of any other equivalent force, e.g. an environment in which a centrifugal force simulate the earth gravity effect), causes rotation of the arms and the vessels along the closed loop path, following release of the stop means.

While moving downwards, the expanded vessel 104e moves also outwardly, due to the effect of the peripheral rails 110. This increases the momentum of the force impressed by the expanded vessel 104e on the arms, improving the rotation of the arms. Conversely, the compressed vessel 104c moving upwards moves also toward the center of the mechanism, towards the arm rotation axis. This decreases the value of the force necessary to move the compressed vessel up. In general, the arms work as a first type lever with a substantial improvement of the clockwise rotation effect.

To obtain the vessels expansion/compression action, expansion/compression means 108 are provided, as in the embodiments previously described. The compression/expansion step is substantially the same as the one described for previous embodiments.

In detail, the highest vessel, in the stop/start position NAP of the arms, undergoes an expansion action, whereas the lowest vessel undergoes a compression action, thus causing the fluid to shift from the lowest vessel to the highest vessel, during the compression/expansion step (FIG. 10).

This action has the aim of restoring each time the initial condition.

A guide element 111 (e.g. a curved plate) is positioned along the path of the compressed vessel 104c going up. The guide element 111 has a curved contour facing away from the rotation axis of the arms 102. The guide element 111 is positioned in such a way that the compressed vessel 104c, while going up, is made to slide resting on the curved contour.

The effect thus obtained is that part of the weight of the compressed vessel 104c is supported by the curved contour of the guide element 111 via the rollers 106, in particular at the uppermost section of the closed loop path, where the compressed vessel 104c is overturned.

So, the expanded vessel 104e going down must only compensate the weight of the compressed vessel 104c hanging from the arms. This further improves the rotational process of the mechanism and a still grater force in impress by the expanded vessel 104e on the arms.

A possible variation includes the fact that the ends of the arms are curved along the length or part of the length where the slots 105 extend as schematically shown in FIG. 13. This improves and smoothes the radial motion of the vessels during rotation of the arms.

A series of improvements can be made.

According to a first improvement, the upper part of the peripheral rails 110 can be slightly flattened. In this way, the compressed vessel 104c going up does not have to reach the uppermost point in the closed loop path, making the rotational process at this point easier. Accordingly, the expanded vessel 104e can impress a grater force on the arms, as it has not to balance a certain length of the upward movement of the compressed vessel 104c.

In case the inertia of the expanded vessel 4e were not sufficient at the end of the downward movement to have it overturned in order to displace the water to the upper compressed vessel 104c, further improvements can be introduced.

A rope 113 can be placed between the hub 103 and the vessels 104c, 104e, this rope having such a length that the vessel 104e each time going downwards does not rotate beyond a certain angle with respect to the arms 102. As a result of this, when the arms arrive at the start/stop position NAP, the vessel 104c must be rotated only over an angle smaller than it would be without the rope.

Another possible improvement (not shown in the Figures) includes power means connected to the hinges of the vessels, such as, but not limited to, a motor, designed to impart each time the expanded vessel 104e a partial rotation necessary to complete overturning. The motor can be activated at the moment in which the expanded vessel 104e will reverse it oscillation, thus making the vessel complete the oscillation motion and get overturned. Means can be provided to control the motor, such as but not limited to a sensor detecting the oscillation reversal.

The motor can be powered by a battery charged for instance by a generator connected to the output shaft of the rotary mechanism.

Other means, for instance mechanical, can be provided in place of the motor. For instance, a leaf spring (not shown) can be connected to the hinge of each vessel, so that when the expanded vessel 104e moves downwards and oscillates in the counterclockwise direction; energy in excess is used to load the spring, which then helps the vessel at a later time with its elastic reaction.

Advantageously, both the spring and the motor can be mounted on the rotary mechanism.

Other mechanical means can be provided for performing the same action, these means being possibly known or easily conceived by those skilled in the art.

The overturning means action appears to be evident to the person skilled in the art, and the final result thereof is setting the cylinder 104e in vertical position, resting on the arms 102.

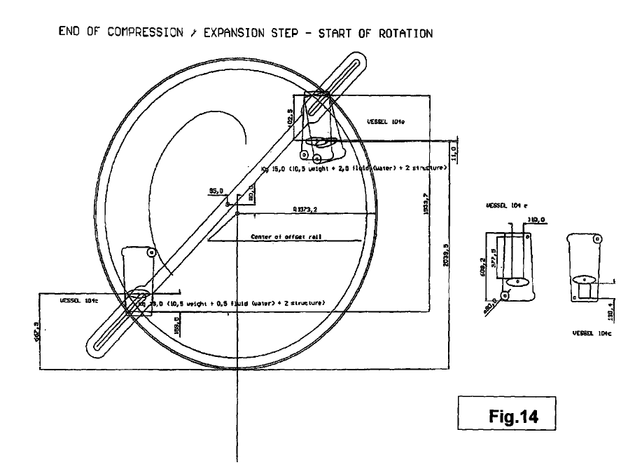

Just as an example, without any intention of limiting the possible implementations, FIG. 14 shows some dimensions (in mm) and weights of a working embodiment.

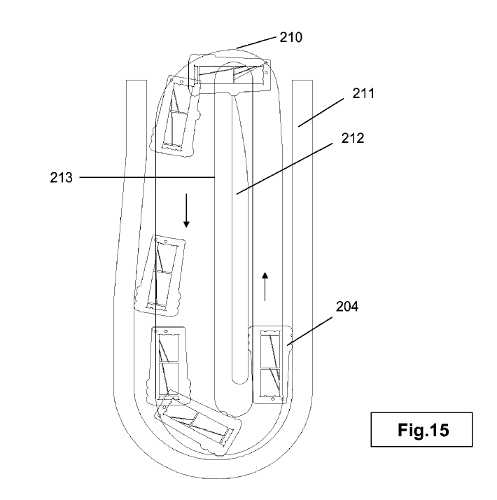

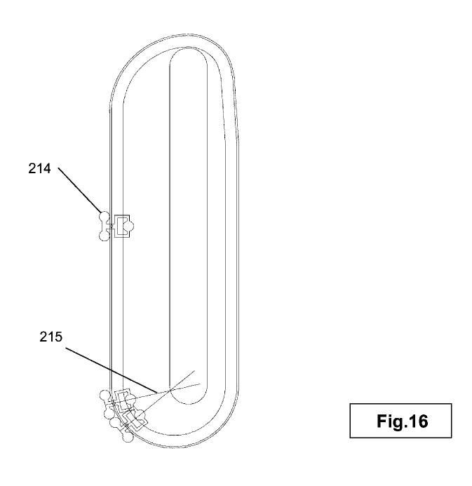

According to another embodiment schematically shown in FIG. 15, and without departing from the scope of the invention, the transmission is made by a chain 213 instead of an arm and the vessels 204 are hinged to respective carriages operatively linked to each other and conducted along first rails 210 (the connection 215 between the vessel and the chain is not shown on FIG. 15 as well as the carriages 214, but they are schematically represented in FIG. 16).

In this case, the first rails 210 are flattened in the ascending and descending portions, so as to define two vertical straight path lengths, connecting upper and lower semi circular path lengths.

An outer rail 211 is provided externally alongside the descending vertical straight path length, the lower semi circular path length 272b and the ascending vertical straight path length.

When the expanded vessel 204 moves downwards along the descending vertical straight path length, it is kept in upright position by the outer rail 211 until it becomes stopped by the stop means (not shown), at the inlet of the ascending vertical straight path length, to transfer the water to the compressed vessel (in a similar way as described for previous embodiments), positioned along the upper semi circular path length, at the inlet of the descending vertical straight path length.

The vessels 204 have lateral extensions designed to slide over a curved plate 212, concentric with the upper semi circular path length, while overturning along the upper semi circular path length. The effect is the same of the guide means 111 in the previously described embodiment.

In other words the mechanism shown in FIG. 14 can be described as a mechanism for transferring a fluid or incoherent material between variable volume vessels alternatively positioned at different heights, the vessels being in closed circuit communication with each other and cyclically compressed/expanded so as to transfer the fluid or incoherent material from the vessel under compression to the vessel under expansion, the mechanism including:
at least two variable volume vessels, in fluid communication, hinged to respective carriages operatively linked to each other and running along a closed loop rail so that they can move along a closed loop path while keeping opposite positions with respect to said path, and with a stop/start position determined for the carriages by stop means, with one of said vessels in expanded condition containing a quantity of fluid greater than the other one of said vessels in compressed condition, so that the expanded vessel, the highest along the path, at the stop/start position, makes the carriages and vessels run along said path following release of said stop means, thus moving downwards the expanded vessel and upwards the compressed vessel due to gravitational force effect;
expansion/compression means acting alternatively to expand/compress said vessels in accordance with the position taken by the carriages, so that the highest vessel, with the carriages at the stop/start positions at the end of a rotation cycle, undergoes an expansion action, whereas the lowest vessel undergoes a compression action, thus causing the fluid to shift from the lowest vessel to the highest vessel, so restoring the initial condition;

wherein the variable volume vessels oscillate while the carriages run along said closed loop rail to help the motion of said variable volume vessels while they are moving from up downwards and from down upwards.

In the mechanism described above, the closed loop rail preferably includes two vertical straight path lengths, connecting upper and lower semi circular path lengths. Also the mechanism can include a frame provided externally alongside the descending vertical straight path length the lower semi circular path length and partially the ascending vertical straight path length, so that the expanded vessel while moving downwards along the descending vertical straight path length is kept in upright position by said frame. In another possible embodiment, the mechanism includes a curved plate, concentric with the upper semi circular path length, on which said vessels slide while overturning along the upper semi circular path length. Also the vessels can have lateral extensions designed to slide over said plate.

Although in the previous paragraphs the mechanism of the present invention has been described with particular implementing details, many other variants are possible to obtain a mechanism as claimed in the following. Also it should be noted that the meaning of “vessels” should be taken in a broad sense as well as the meaning of “fluid”: it is possible to implement the same mechanism with different, but equivalent components: just to make an example, the function of the fluid being pushed from a lower to a higher level by means of a pair of weights attracted by a gravitational force could be realized by a chain wrapped around two rotating wheels, where the pressure of the weight causes the rotation of the two wheels with the unwrapping from the lower wheel and wrapping on the higher wheel.

1. A mechanism for transferring a fluid from at least a first vessel to at least a second vessel placed at a higher height with respect to the first vessel, the mechanism including:
at least a first and a second variable volume vessels, the at least first and second vessel being in close circuit fluid communication; the at least second vessel being positioned upside-down with respect to the at least first vessel;
compression/expansion means coupled to each vessel acting to contemporarily compress the at least first vessel and expand the at least second vessel, so that the at least first vessel undergoes a compression action and the at least second vessel undergoes an expansion action, thus causing the fluid to shift from the at least first vessel to the at least second vessel;
wherein the compression/expansion means are activated by a gravitational force.

2. A mechanism as in claim 1 wherein the compression/expansion means include a weight coupled to each vessel, the weight exerting a compression action on the at least first vessel and an expansion action on the at least second vessel.

3. A mechanism as in claim 1, wherein said variable volume vessels are constituted by concentric stiff cylinders placed inside a flexible tight container.

4. A mechanism as in claim 3, wherein the cylinders are made of a sufficiently stiff material capable of resisting the expansion and compression force caused by the gravitational force.

5. A mechanism as in claim 4, wherein the material is one of the following: a metallic material, holed metal sheet, plastic material or a combination thereof.

6. A rotating mechanism supporting the mechanism of claim 1, wherein the at least first and second variable volume vessels are alternatively positioned at different heights, the at least first and second variable volume vessels being hinged to the rotating mechanism so that the first and second variable volume vessels can move along a closed loop path while keeping opposite positions with respect to said path, the rotating mechanism further including:
stop means for determining a stop/start position for the rotating mechanism;
wherein expansion/compression means act alternatively to expand/compress the at least first and second vessels in accordance with a position taken by the rotating mechanism, so that, with the rotating mechanism at the stop/start position, at the end of a rotation cycle, a highest vessel undergoes an expansion action and a lowest vessel undergoes a compression action, thus causing the fluid to shift from the lowest vessel to the highest vessel, which determines rotation of the vessels along the path following release of the stop means, thus moving downwards the expanded vessel and upwards the compressed vessel due to gravitational force effect and restoring an initial condition;
and wherein the variable volume vessels oscillate during rotation to help the rotating mechanism rotation.

7. A rotating mechanism as in claim 6, wherein the at least first and second vessels are moved outwardly with respect to the closed loop path going away from a rotation axis, when the first and second vessels are in an expanded condition, and inwardly with respect to the closed loop path going closer to the rotation axis, while the first and second vessels are in a compressed condition, so as to increase momentum when the first and second vessels move downwards and reduce momentum when the first and second vessels move upwards.

8. A rotating mechanism as in claim 7, wherein said vessels are moved outwardly, while going down, and inwardly while going up.

9. A rotating mechanism as in claim 6, further including:
locking/unlocking means acting on the variable volume vessels so as to release the vessels, during rotation of said rotating mechanism, so that the vessels oscillate to help rotation of the rotating mechanism, and to lock the vessels, when the rotating mechanism dwells at the stop/start position, in a position such as to promote action of the expansion/compression means and fluid shifting from the lowest vessel to the highest vessel.

10. A rotating mechanism as in claim 6, wherein the stop mean include magnetic or electromagnetic or mechanical devices or a combination thereof.

11. A rotating mechanism as in claim 6, including at least one arm, pivoted to a support at a central position, so as to rotate coaxially in a substantially vertical plane with respect to the stop/start position determined by the stop means, with the variable volume vessels being each hinged to opposite ends of said arm.

12. A mechanism as in claim 6, wherein the arm is connected to the support by means of a hub situated at its barycenter, and wherein the support includes a pedestal or base, onto which one or two uprights are mounted, arranged substantially in vertical.

13. A rotating mechanism as in claim 6, including at least one arm, pivoted to a support at a central position, so as to rotate coaxially in a substantially vertical plane with respect to said stop/start position determined by said stop means, wherein each end of at least one arm includes first guide means extending longitudinally from the respective end toward a center of the respective arm, and wherein the variable volume vessels are in sliding engagement with the first guide means at each of the opposite ends of the at least one arm.

14. A rotating mechanism as in claim 11, wherein said arm is built with a substantially “Z”-like shape.

15. A rotating mechanism as in claim 13, wherein radial moving means are provided which include at least one peripheral rail, with which the variable volume vessels are in sliding engagement.

16. A rotating mechanism as in claim 15, wherein the at least one peripheral rail has its center offset toward a descending side of rotation, and downwards.

17. A rotating mechanism as in claim 15, wherein an [[the]] upper part of the at least one peripheral rail is slightly flattened, so that the compressed vessel going up does not reach an uppermost point in the closed loop path.

18. A rotating mechanism as in claims 15, including second guide means positioned along the path of the compressed vessel going up, the second guide means having a curved contour facing away from the pivot point of the at least one arm and positioned in such a way that the at least one compressed vessel, while going up, slides resting on the curved contour, so that the at least one compressed vessel is supported in part by the curved contour of the second guide means while being overturned.

19. A rotating mechanism as in claims 15, wherein the at least one arm is connected to the support by means of a hub situated at its barycenter, with the support composed of a pedestal or base, onto which one or two upright structures are mounted, arranged substantially in vertical at both sides of said arm.

20. A rotating mechanism as in claims 15, wherein at least two arms are connected to the support and are arranged parallel to each other, with each vessel being hinged to corresponding ends of both arms, and two peripheral rails are provided for radial movement of the vessels.

21. A rotating mechanism as in claims 15, wherein the ends of the at least one arm are curved along length or part of a length along which the first guide means extend.

22. A rotating mechanism as in claims 15, wherein the first guide means include a slot made longitudinally at each end of the at least one arm.

23. A rotating mechanism as in claims 6, further including:
overturning means for turning the at least one expanded vessel at the end of the rotation, so that the vessels return in the initial condition.

24. A method for producing electric power, by using the rotating mechanism of claims 6.
